(19) United States
(12) Patent Application Publication
(10) Pub. No.: US 2021/0133692 A1
(43) Pub. Date: May 6, 2021

(54) ROUTING PARTICIPANTS TO MEETINGS

(71) Applicant: INTERNATIONAL BUSINESS MACHINES CORPORATION, Armonk, NY (US)

(72) Inventors: Lisa Seacat DeLuca, Baltimore, MD (US); Zachary A. Silverstein, Jacksonville, FL (US); Kelley Anders, East New Market, MD (US); Jeremy R. Fox, Georgetown, TX (US)

(21) Appl. No.: 16/672,612

(22) Filed: Nov. 4, 2019

(51) Int. Cl. G06Q 10/10; G06N 5/02

(52) U.S. Cl. CPC G06Q 10/1095; G06N 5/02

(57) ABSTRACT

The exemplary embodiments disclose a system and method, a computer program product, and a computer system for routing participants to meetings. The exemplary embodiments may include determining whether a participant has a unique identification number (UID) that matches a meeting UID, collecting participant data corresponding to the participant, extracting one or more features from the collected participant data, and routing the participant to join one or more meetings based on applying one or more models to the extracted one or more features.

### BACKGROUND

The exemplary embodiments relate generally to meetings, and more particularly to the routing of participants to concurrent meetings.

People often host teleconferences or video conferences where a first meeting may take more time than expected and continue past the start time of a second meeting. In such cases, participants of the second meeting may attempt to join the second meeting at its scheduled start time, and unintentionally join the first meeting instead, exposing them to information they may not be intended to receive. In such circumstances, it is necessary to appropriately separate concurrent meetings and their participants.

### SUMMARY

The exemplary embodiments disclose a system and method, a computer program product, and a computer system for routing participants to meetings. The exemplary embodiments may include determining whether a participant has a unique identification number (UID) that matches a meeting UID, collecting participant data corresponding to the participant, extracting one or more features from the collected participant data, and routing the participant to join one or more meetings based on applying one or more models to the extracted one or more features.

### BRIEF DESCRIPTION OF THE SEVERAL VIEWS OF THE DRAWINGS

The following detailed description, given by way of example and not intended to limit the exemplary embodiments solely thereto, will best be appreciated in conjunction with the accompanying drawings, in which:

FIG. 1 depicts an exemplary schematic diagram of a routing system 100, in accordance with the exemplary embodiments.

FIG. 2 depicts an exemplary flowchart 200 illustrating the operations of a participant router 136 of the routing system 100 in the routing of participants to one or more meetings, in accordance with the exemplary embodiments.

FIG. 3 depicts an exemplary block diagram depicting the hardware components of the routing system 100 of FIG. 1, in accordance with the exemplary embodiments.

FIG. 4 depicts a cloud computing environment, in accordance with the exemplary embodiments.

FIG. 5 depicts abstraction model layers, in accordance with the exemplary embodiments.

The drawings are not necessarily to scale. The drawings are merely schematic representations, not intended to portray specific parameters of the exemplary embodiments. The drawings are intended to depict only typical exemplary embodiments. In the drawings, like numbering represents like elements.

### DETAILED DESCRIPTION OF THE SEVERAL VIEWS OF THE DRAWINGS

Detailed embodiments of the claimed structures and methods are disclosed herein; however, it can be understood that the disclosed embodiments are merely illustrative of the claimed structures and methods that may be embodied in various forms. The exemplary embodiments are only illustrative and may, however, be embodied in many different forms and should not be construed as limited to the exemplary embodiments set forth herein. Rather, these exemplary embodiments are provided so that this disclosure will be thorough and complete, and will fully convey the scope to be covered by the exemplary embodiments to those skilled in the art. In the description, details of well-known features and techniques may be omitted to avoid unnecessarily obscuring the presented embodiments.

References in the specification to “one embodiment”, “an embodiment”, “an exemplary embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the interest of not obscuring the presentation of the exemplary embodiments, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is focused on the distinctive features or elements according to the various exemplary embodiments.

People often host teleconferences or video conferences where a first meeting may take more time than expected and continue past the start time of a second meeting. In such cases, participants of the second meeting may attempt to join the second meeting at its scheduled start time, and unintentionally join the first meeting instead, exposing them to information they may not be intended to receive. In such circumstances, it is necessary to appropriately separate concurrent meetings and their participants.

Exemplary embodiments are directed to a method, computer program product, and computer system that will route participants to appropriate meetings. In embodiments, machine learning may be used to create models capable of determining which participants are routed to which meetings, while feedback loops may improve upon such models. Moreover, data from the meetings, user and participant profiles, sensors, the internet, and social networks may be utilized. In embodiments, such meetings may take place via telephone, the internet (VOIP), Bluetooth, and the like. In general, it will be appreciated that embodiments described herein may relate to aiding in the routing of participants to meetings within any environment.

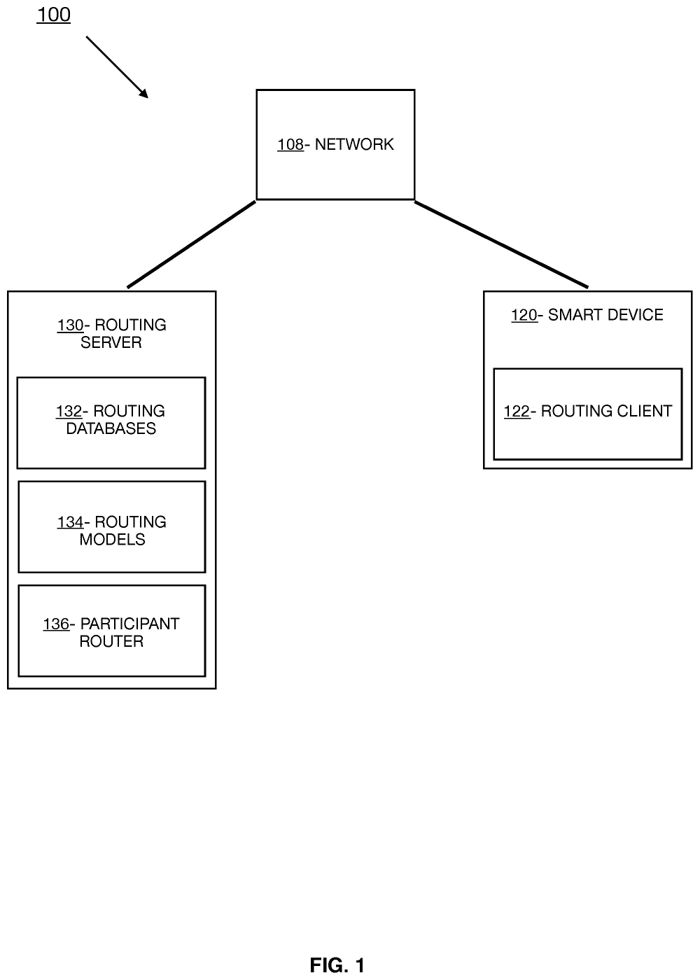

FIG. 1 depicts the routing system 100, in accordance with the exemplary embodiments. According to the exemplary embodiments, the routing system 100 may include a smart device 120 and a routing server 130, which may be interconnected via a network 108. While programming and data of the exemplary embodiments may be stored and accessed remotely across several servers via the network 108, programming and data of the exemplary embodiments may alternatively or additionally be stored locally on as few as one physical computing device or amongst other computing devices than those depicted.

In the exemplary embodiments, the network 108 may be a communication channel capable of transferring data between connected devices. Accordingly, the components of the routing system 100 may represent network components or network devices interconnected via the network 108. In the exemplary embodiments, the network 108 may be the Internet, representing a worldwide collection of networks and gateways to support communications between devices connected to the Internet. Moreover, the network 108 may utilize various types of connections such as wired, wireless, fiber optic, etc. which may be implemented as an intranet network, a local area network (LAN), a wide area network (WAN), or a combination thereof. In further embodiments, the network 108 may be a Bluetooth network, a Wi-Fi network, or a combination thereof. In yet further embodiments, the network 108 may be a telecommunications network used to facilitate telephone calls between two or more parties comprising a landline network, a wireless network, a closed network, a satellite network, or a combination thereof. In general, the network 108 may represent any combination of connections and protocols that will support communications between connected devices.

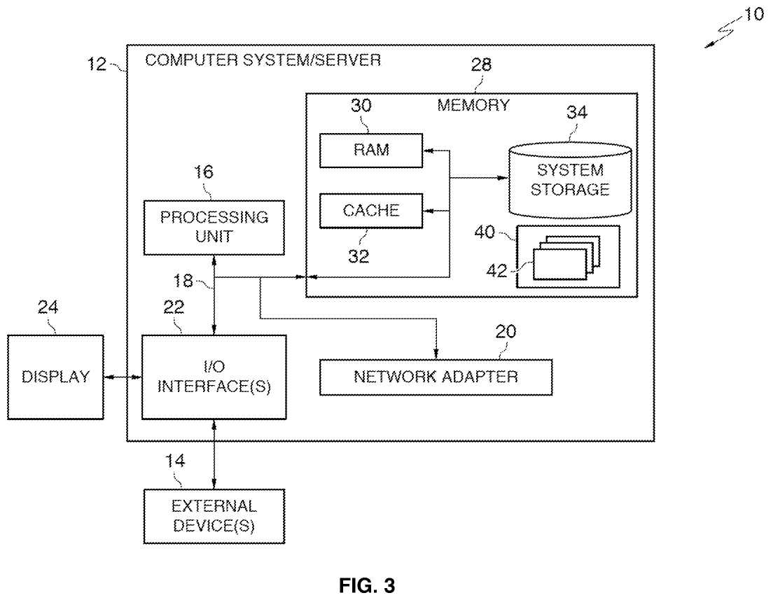

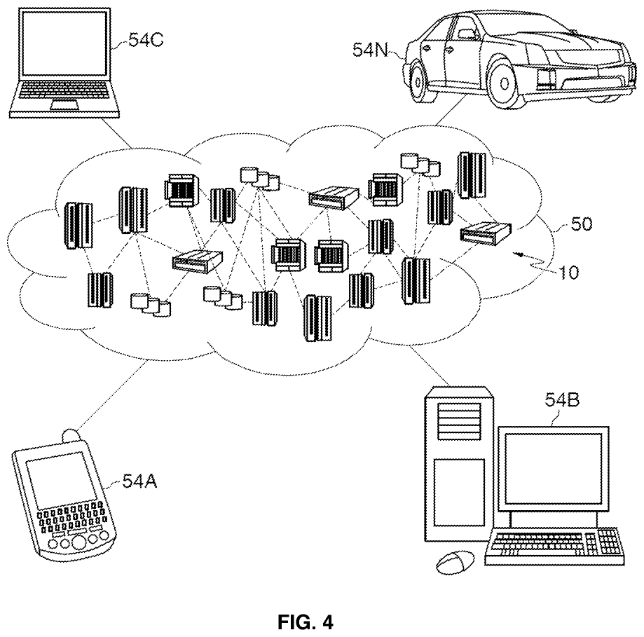

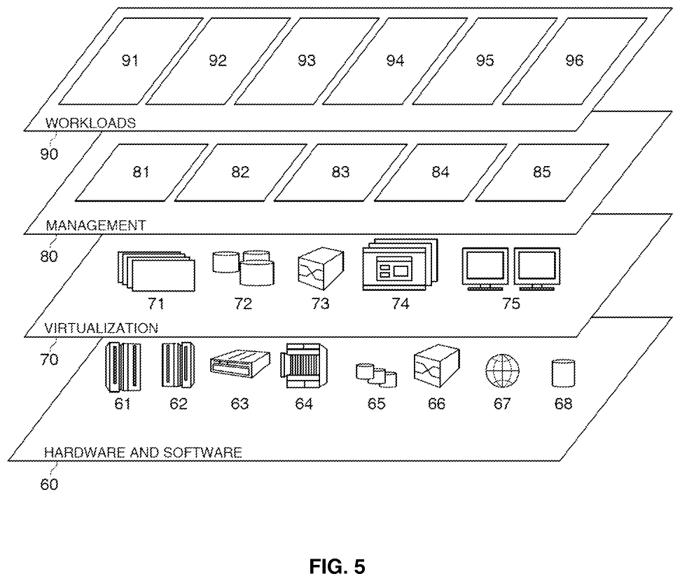

In the example embodiment, the smart device 120 includes a routing client 122, and may be an enterprise server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, an IoT device, or any other electronic device or computing system capable of receiving and sending data to and from other computing devices. While the smart device 120 is shown as a single device, in other embodiments, the smart device 120 may be comprised of a cluster or plurality of computing devices, in a modular manner, etc., working together or working independently. The smart device 120 is described in greater detail as a hardware implementation with reference to FIG. 3, as part of a cloud implementation with reference to FIG. 4, and/or as utilizing functional abstraction layers for processing with reference to FIG. 5.

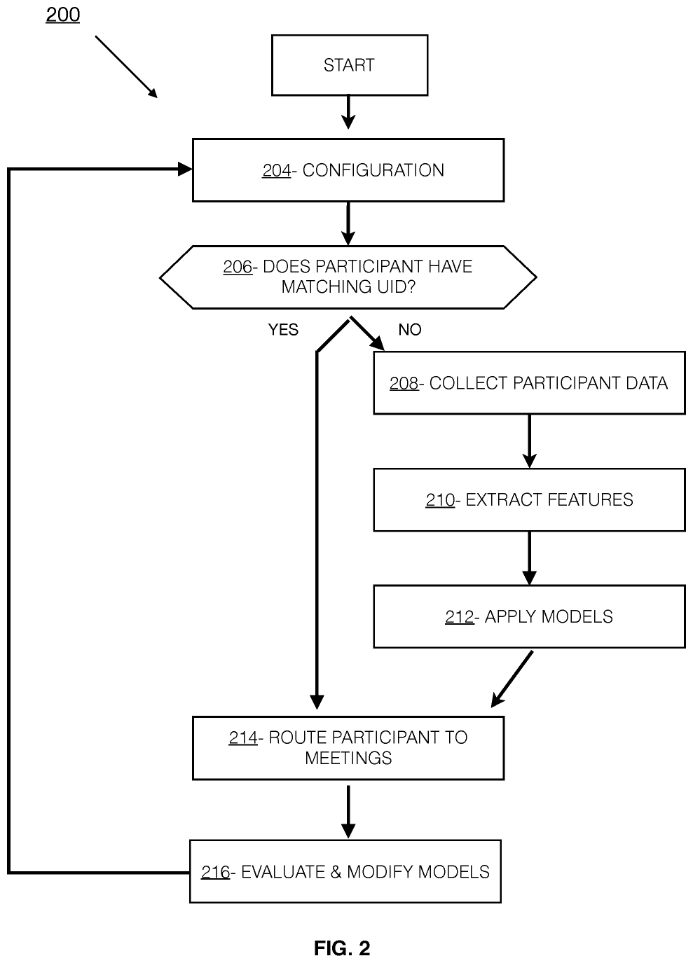

The routing client 122 may be a software and/or hardware application capable of communicating with and providing a user interface for a user to interact with a server via the network 108. The routing client 122 may act as a client in a client-server relationship. Moreover, in the example embodiment, the routing client 122 may be capable of transferring data between the smart device 120 and other devices via the network 108. In embodiments, the participant router 136 utilizes various wired and wireless connection protocols for data transmission and exchange, including Bluetooth, 2.4 gHz and 5 gHz internet, near-field communication, Z-Wave, Zigbee, etc. The routing client 122 is described in greater detail with respect to FIG. 2.

In the exemplary embodiments, the routing server 130 includes one or more routing databases 132, one or more routing models 134, and a participant router 136. The routing server 130 may act as a server in a client-server relationship with the routing client 122, and may be an enterprise server, a laptop computer, a notebook, a tablet computer, a netbook computer, a PC, a desktop computer, a server, a PDA, a rotary phone, a touchtone phone, a smart phone, a mobile phone, a virtual device, a thin client, an IoT device, or any other electronic device or computing system capable of receiving and sending data to and from other computing devices. While the routing server 130 is shown as a single device, in other embodiments, the routing server 130 may be comprised of a cluster or plurality of computing devices, working together or working independently. The routing server 130 is described in greater detail as a hardware implementation with reference to FIG. 3, as part of a cloud implementation with reference to FIG. 4, and/or as utilizing functional abstraction layers for processing with reference to FIG. 5.

In the exemplary embodiments, the routing databases 132 may be a collection of organized data which details the information of one or more participants, employees, organizations, entities, etc. The routing databases 132 may additionally include information regarding previous and future meetings of such participants, employees, organizations, entities, etc. In the example embodiment, data detailed by the routing databases 132 includes relevant meeting identification information such as unique identification numbers of concurrent meetings (UIDs), as well as participant data such as name, job title, business unit, clearance level, seniority, qualifications, home location, work location, hobbies, interests, and the like. The routing databases 132 may additionally include social media or messaging information across platforms such as email, text message, social media messaging, and the like. In the example embodiment, the routing databases 132 are stored on routing server 130. In other embodiments, however, the routing databases 132 may be stored elsewhere, such as on the smart device 120.

The routing models 134 may be one or more algorithms modelling a correlation between one or more features and an appropriate meeting. The one or more features may include name, employer, job title, security clearance, responsibilities, extracurricular activities, plans, hobbies, and the like, and may be extracted via the routing client 122 and the network 108. In embodiments, the routing models 134 may weight the features based on an effect that the one or more features have on a participant being routed to the appropriate one or more meetings. In the example embodiment, the participant router 136 may generate the routing models 134 using machine learning methods, such as neural networks, deep learning, hierarchical learning, Gaussian Mixture modelling, Hidden Markov modelling, and K-Means, K-Medoids, or Fuzzy C-Means learning, etc. The routing models 134 are described in greater detail with reference to FIG. 2.

The participant router 136 may be a software and/or hardware program capable of receiving a configuration of the routing system 100. In addition, the participant router 136 may be further configured for collecting and processing participant data. Moreover, the participant router 136 may be configured for aggregating the processed data and applying one or more routing models 134 to the collected and processed participant data in order to assign one or more participants to one or more appropriate meetings. Lastly, the participant router 136 is capable of evaluating the routing of one or more participants to one or more appropriate meetings, and adjusting its models based on the evaluation. The participant router 136 is described in greater detail with reference to FIG. 2.

FIG. 2 depicts the exemplary flowchart 200 illustrating the operations of a participant router 136 of the routing system 100 in routing participants to meetings, in accordance with the exemplary embodiments.

The participant router 136 may receive a configuration (step 204). The participant router 136 may be configured by receiving a user registration. In the example embodiment, the configuration may be received by the participant router 136 via the routing client 122 and the network 108. In embodiments, a user may be the host of one or more meetings, and receiving a user registration may involve receiving demographic and other information about a participant or user such as a name, username, home location, a type of the smart device 120, a serial number of smart device 120, and the like. The participant router 136 may further receive information relating to the profession of a user or participant, such as a company name, department name, job title/role, serial number, responsibilities, site locations, etc. Moreover, the participant router 136 may further receive any other information relevant to a user or participant's interests, such as information regarding extracurricular activities, plans, hobbies, etc. In embodiments, the participant router 136 may prompt a user to populate a user profile via user input. In addition, the participant router 136 may extract a user or participant's profile, calendar, or meeting schedule from one or more databases, such as business directories, employee listings, government listings, social networks, smart device 120 contacts, email contacts, social media contacts, and the like, which may be stored in the routing databases 132. For example, the participant router 136 may determine one or more names, job titles, home locations, work locations, hobbies, interests, or other credentials associated with both the user and, in embodiments, one or more friends, co-workers, entities, and other contacts having a relationship with a user. The participant router 136 may additionally receive or extract information relating to a user's meetings, such as meeting UIDs, names of meetings, start and end times of meetings, invited participants of meetings, descriptions of meetings, security clearance of meetings, etc. to be stored in routing databases 132. The participant router 136 may also create meetings based on received information relating to a user's meetings.

To further illustrate the operations of the participant router 136, reference is now made to an illustrative example where a user uploads a user registration with a link to his email contacts database and information about his upcoming concurrent meetings he is hosting: “Project A discussion” and “Project B discussion.” “Project A discussion” is a high security clearance meeting with software developers at Company X to discuss the advancement of Project A that is scheduled to last from 9 am to 10 am. “Project B discussion” is a low security clearance meeting with friends to discuss community service project Project B that is scheduled to last from 9:45 am to 10:45 am.

Upon detecting a participant attempting to join a user's meeting, the participant router 136 may determine whether a participant has a matching UID (decision 206). In embodiments, a participant's UID may be present in a meeting invitation or web link sent to the participant to join a meeting. In other embodiments, a participant's UID may be in the form of a password, and the participant may be prompted to enter their UID. The participant router 136 may determine whether the participant UID matches that of the meeting by comparing a participant's one or more UIDs to the meeting UID.

With reference again to the previously introduced example wherein the user uploaded a user registration, if the user is hosting the Project A meeting and the meeting continues past the start time of the Project B meeting such that both meetings are taking place concurrently, and a participant attempts to join a meeting, the participant router 136 compares the UID of the joining participant to the UIDs for meetings “Project A discussion” and “Project B discussion.”

Based on determining that the participant UID does not match the UIDs of a user's meetings (decision 206, “NO” branch), the participant router 136 may collect participant data (step 208). Participant data may include name, username, employer, job title, security clearance level, interests, photo, audio recording, video recording, fingerprint, voiceprint, etc. In order to collect this data, the participant router 136 may collect data received by the smart device 120 from the participant via the routing client 122 and the network 108. When a participant attempts to join a meeting, for example, the participant router 136 may extract an identification number and corresponding participant name via ID functions and/or reverse lookup. In embodiments utilizing voice over internet protocol (VOIP) or internet-based communications, the participant router 136 may extract a username, IP address, MAC address, web address, email address, etc. associated with a device and corresponding participant name, job/title, business unit, qualifications, clearance level, etc. via the network 108 and an internet directory. In addition to participant username, IP address, name, etc., the participant router 136 may further extract additional participant data from the audio and/or video of a participant's response to a prompt. For example, the participant router 136 may prompt a participant for identification/purpose to extract a voiceprint of the participant from an audio feed or a faceprint of the participant via a video feed. For example, the participant router 136 may play a recorded message of the user saying “Hello, please state your name and the meeting you intend to join,” and extract a voiceprint of the participant from the participant's response to the prompt. In embodiments, the participant router 136 may utilize natural language processing techniques and methods such as topic modeling to extract a topic, purpose, etc. from the participant response.

With reference again to the previously introduced example wherein the participant attempts to join one or more of the user's meetings, if the participant router 136 determines that the participant's UID does not match any of the user's meeting UIDs, then the participant router 136 extracts the participant's name “John Smith,” employer Company Y, job title human resources manager, security clearance none, and interest community service via the user's email contacts and prompts the participant with, “Hello, please state a brief description of the meeting you intend to join.” The participant router 136 further extracts a voiceprint of the participant's response, “I intend to join a meeting regarding Project B discussion.”

The participant router 136 may extract features from the data (step 210). In embodiments, the extracted features may include a name, username, serial number, employer, job title, security clearance, responsibilities, extracurricular activities, plans, hobbies, etc. which may be compared to information about meetings, the user, and/or other participants in the routing databases 132 through use of a model that weights the extracted features and outputs scores indicative of how likely it is that a participant should be routed to each meeting. The participant router 136 may process the participant data to identify a participant's name, employer, job title, security clearance, responsibilities, extracurricular activities, plans, hobbies, etc. Participant data may be extracted from social networks, an employee database, a user profile, etc. or from a participant's response to a prompt, as discussed earlier. The participant data may be compared to a user's meeting information as well as the identities of the user and other participants in a user's meetings to determine if the participant should be routed to any meetings, and may be expressed as scores. For example, if a meeting description lists names and serial numbers of invited meeting participants and a participant has a name and serial number that is on the list, the participant router 136 may treat the participant as having a high name score. If a participant has a name and serial number that is not on the list, the participant router 136 may treat the participant as having a low name score. If a meeting description states that the meeting is to discuss software development at Company X, the participant router 136 may treat a participant with job title “software developer at Company X” as having high employer and job title scores. If a meeting has ten participants, all with “human resources manger at Company Y” as their job titles, the participant router 136 may treat a participant with job title “software developer at Company X” as having low employer and job title scores. In an example where a meeting description states that content to be discussed requires a high security clearance level, the participant router 136 may treat a participant with a low security clearance level as having a low security clearance score, and may treat a participant with a high security clearance level as having a high security clearance score. If a meeting description lists “Softball Tournament” as its description and a participant's profile lists participation in a softball club as an extracurricular activity, the participant router 136 may treat the participant as having a high extracurricular score. In another example, a meeting's participants all have volunteering listed as hobbies on their profiles, the participant router 136 may treat a participant without volunteering listed as a hobby as having a low hobby score. If a participant responded to a prompt with “I intend to join the meeting about the basketball club,” and a meeting lists description “Basketball Club discussion,” the participant router 136 may treat the participant as having a high hobby score.

With reference again to the previously introduced example wherein the user responded to the prompt with, “I intend to join a meeting regarding Project B discussion,” the participant router 136 determines from the participant's name “John Smith,” employer Company Y, job title human resources manager, security clearance none, interest community service, and response to the prompt that the participant has low name, employer, job title, security clearance, and interest scores for meeting “Project A discussion,” and high name, employer, job title, security clearance, and interest scores for meeting “Project B discussion.”

The participant router 136 may apply one or more models to the extracted features (step 212). In embodiments, this may involve the participant router 136 computing a value indicative of whether a participant should be routed to a meeting based on the one or more extracted features. In some embodiments, each of the features may be weighted by the routing models 134 such that features shown to have a greater association with the appropriate meeting for a participant are weighted greater than those features that are not. Such weighting may be accomplished through machine learning techniques such as neural networks, hierarchical learning, or regularization. Such techniques may assign weights to the features that are trained and modified through use of a feedback loop indicative of whether the one or more meetings were appropriate for a participant and which features were most relied upon in the determination, etc. The feedback loop is described in greater detail below. In some embodiments, the features may be numeric values that are multiplied by the numeric weighting values associated with said features by the routing models 134. The sum of the multiplication of said feature values and weighting values may result in numeric values representing scores for the participant corresponding to each meeting, indicative of how good a fit the participant is for each meeting.

With reference again to the previously introduced example wherein the participant router 136 determined that the participant has low name, employer, job title, security clearance, and interest scores for meeting “Project A discussion,” and high name, employer, job title, security clearance, and interest scores for meeting “Project B discussion,” the participant router 136 determines that the participant's “Project A discussion” score is 0.2, which is below threshold 0.6, and that the participant's “Project B discussion” score is 0.9, which is above threshold 0.6.

Based on determining that the participant UID does not match the UIDs of a user's meetings (decision 206, “YES” branch), or after applying the models to the extracted features, the participant router 136 may route a participant to join one or more meetings (step 214). In some embodiments, a participant's scores may all be below a threshold value, and the participant may be placed on hold to wait for the user to manually route the participant to a meeting. In some embodiments, a participant may have multiple scores above a threshold value, and the participant router 136 may give the participant the option to choose which of those meetings they wish to be routed to, or may route the participant to all or more than one of those meetings. In other embodiments, the participant router 136 may simply determine that a participant is to be routed to the single meeting with the highest score. In addition to routing a participant to meetings, the participant router 136 may also notify the user of the routing of a participant. In some embodiments, the participant router 136 may display its routing of a participant on a user's smart device 120 or other device, such as their smart phone, smart tablet, augmented reality glasses, smart watch, etc. In embodiments, the participant router 136 may prompt a user for permission to route a participant to a meeting prior to routing the participant to the meeting.

With reference again to the previously introduced example wherein the participant router 136 determines that the participant's “Project A discussion” score is 0.2, which is below threshold 0.6, and that the participant's “Project B discussion” score is 0.9, which is above threshold 0.6, the participant router 136 routes the participant to the “Project B discussion.”

The participant router 136 may evaluate and modify the routing models 134 (step 216). In the example embodiment, the participant router 136 may verify whether the routing of a participant was optimized appropriately in order to provide a feedback loop providing the capability to modify and tweak models and weighting values utilized in routing the participant. In embodiments, the feedback loop may simply provide a means for a user to indicate whether they approve of the routing of a participant to one or more meetings. For example, the participant router 136 may prompt a user to select an option indicative of whether the routing of a participant to one or more meetings was incorrect. The option may comprise a toggle switch, button, slider, etc. that may be selected by the user manually by hand using a button/touchscreen/etc., by voice, by eye movement, and the like. If the user were to respond with “incorrect routing” after the participant router 136 routed a participant, the participant router 136 may modify its models to less heavily weight the features used in routing that participant. Conversely, if the user were to respond with “correct routing” after the participant router 136 routed a participant, the participant router 136 may modify its models to more heavily weight the features used in routing that participant. In other embodiments, the participant router 136 may infer or deduce whether a participant was appropriately routed by detecting a participant leaving a meeting shortly after being routed to the meeting. For example, if the user immediately removes a participant from a meeting after the participant router 136 routes a participant to the meeting, or if a participant immediately leaves a meeting after the participant router 136 routes a participant to the meeting, the participant router 136 may infer that the participant was incorrectly routed to the meeting. In addition, the participant router 136 may interpret user dialogue via natural language processing to determine that the participant was incorrectly routed. For example, if the user says, “sorry, you are in the wrong meeting,” then the participant router 136 may identify that the participant has been routed to the incorrect meeting and adjust the routing models 134. In some embodiments, the participant router 136 may prompt a participant to select an option indicative of whether the participant router 136 routed them incorrectly, and may modify its routing models 134 based on this feedback.

With reference again to the previously introduced example wherein the participant router 136 routes the participant to the “Project B discussion” meeting, the participant router 136 prompts the user to identify whether the routing of the participant was “correct” or “incorrect” after the user ends the “Project B discussion” meeting. The user responds by selecting “correct” and the participant router 136 modifies its models to more heavily weight the features used in routing that participant to the “Project B discussion” meeting.

FIG. 3 depicts a block diagram of devices within the participant router 136 of the routing system 100 of FIG. 1, in accordance with the exemplary embodiments. It should be appreciated that FIG. 3 provides only an illustration of one implementation and does not imply any limitations with regard to the environments in which different embodiments may be implemented. Many modifications to the depicted environment may be made.

Devices used herein may include one or more processors 02, one or more computer-readable RAMs 04, one or more computer-readable ROMs 06, one or more computer readable storage media 08, device drivers 12, read/write drive or interface 14, network adapter or interface 16, all interconnected over a communications fabric 18. Communications fabric 18 may be implemented with any architecture designed for passing data and/or control information between processors (such as microprocessors, communications and network processors, etc.), system memory, peripheral devices, and any other hardware components within a system.

One or more operating systems 10, and one or more application programs 11 are stored on one or more of the computer readable storage media 08 for execution by one or more of the processors 02 via one or more of the respective RAMs 04 (which typically include cache memory). In the illustrated embodiment, each of the computer readable storage media 08 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Devices used herein may also include a R/W drive or interface 14 to read from and write to one or more portable computer readable storage media 26. Application programs 11 on said devices may be stored on one or more of the portable computer readable storage media 26, read via the respective R/W drive or interface 14 and loaded into the respective computer readable storage media 08.

Devices used herein may also include a network adapter or interface 16, such as a TCP/IP adapter card or wireless communication adapter (such as a 4G wireless communication adapter using OFDMA technology). Application programs 11 on said computing devices may be downloaded to the computing device from an external computer or external storage device via a network (for example, the Internet, a local area network or other wide area network or wireless network) and network adapter or interface 16. From the network adapter or interface 16, the programs may be loaded onto computer readable storage media 08. The network may comprise copper wires, optical fibers, wireless transmission, routers, firewalls, switches, gateway computers and/or edge servers.

Devices used herein may also include a display screen 20, a keyboard or keypad 22, and a computer mouse or touchpad 24. Device drivers 12 interface to display screen 20 for imaging, to keyboard or keypad 22, to computer mouse or touchpad 24, and/or to display screen 20 for pressure sensing of alphanumeric character entry and user selections. The device drivers 12, R/W drive or interface 14 and network adapter or interface 16 may comprise hardware and software (stored on computer readable storage media 08 and/or ROM 06).

The programs described herein are identified based upon the application for which they are implemented in a specific one of the exemplary embodiments. However, it should be appreciated that any particular program nomenclature herein is used merely for convenience, and thus the exemplary embodiments should not be limited to use solely in any specific application identified and/or implied by such nomenclature.

Based on the foregoing, a computer system, method, and computer program product have been disclosed. However, numerous modifications and substitutions can be made without deviating from the scope of the exemplary embodiments. Therefore, the exemplary embodiments have been disclosed by way of example and not limitation.

It is to be understood that although this disclosure includes a detailed description on cloud computing, implementation of the teachings recited herein are not limited to a cloud computing environment. Rather, the exemplary embodiments are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction proper to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 40 with which local computing devices used by cloud consumers, such as, for example, personal digital assistant (PDA) or cellular telephone 54A, desktop computer 54B, laptop computer 54C, and/or automobile computer system 54N may communicate. Nodes 40 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 40 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and the exemplary embodiments are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and participant routing 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for routing one or more participants to meetings, the method comprising:
determining whether a participant UID corresponding to a participant matches a meeting UID;
based on determining that the participant UID does not match the meeting UID, collecting participant data corresponding to the participant;
extracting one or more features from the collected participant data; and
routing the participant to join one or more meetings based on applying one or more models to the extracted one or more features.

2. The method of claim 1, wherein the one or more models correlate the one or more features with the one or more meetings.

3. The method of claim 1, further comprising:
receiving feedback indicative of whether one or more participants were appropriately routed to one or more meetings; and
adjusting the model based on the received feedback.

4. The method of claim 1, further comprising:
prompting one or more participants to provide identification data;
and wherein the collected participant data includes the provided identification data.

5. The method of claim 1, wherein the participant data includes data selected from a group comprising calendars, profiles, schedules, business directories, employee listings, government listings, social networks, smart device contacts, email contacts, social media contacts, audio, video, and text.

6. The method of claim 1, wherein the one or more features include features selected from a group comprising a name, username, serial number, employer, job title, security clearance, responsibilities, extracurricular activities, plans, and hobbies.

7. The method of claim 1, further comprising:
notifying a host of the routing; and
providing the host an option to modify the routing.

8. A computer program product for routing participants to meetings, the computer program product comprising:
one or more non-transitory computer-readable storage media and program instructions stored on the one or more non-transitory computer-readable storage media capable of performing a method, the method comprising:
determining whether a participant UID corresponding to a participant matches a meeting UID;
based on determining that the participant UID does not match the meeting UID, collecting participant data corresponding to the participant;
extracting one or more features from the collected participant data; and
routing the participant to join one or more meetings based on applying one or more models to the extracted one or more features.

9. The computer program product of claim 8, wherein the one or more models correlate the one or more features with the one or more meetings.

10. The computer program product of claim 8, further comprising:
receiving feedback indicative of whether one or more participants were appropriately routed to one or more meetings; and
adjusting the model based on the received feedback.

11. The computer program product of claim 8, further comprising:
prompting one or more participants to provide identification data;
and wherein the collected participant data includes the provided identification data.

12. The computer program product of claim 8, wherein the participant data includes data selected from a group comprising calendars, profiles, schedules, business directories, employee listings, government listings, social networks, smart device contacts, email contacts, social media contacts, audio, video, and text.

13. The computer program product of claim 8, wherein the one or more features include features selected from a group comprising a name, username, serial number, employer, job title, security clearance, responsibilities, extracurricular activities, plans, and hobbies.

14. The computer program product of claim 8, further comprising:
notifying a host of the routing; and
providing the host an option to modify the routing.

15. A computer system for routing participants to meetings, the computer system comprising:
one or more computer processors, one or more computer-readable storage media, and program instructions stored on the one or more of the computer-readable storage media for execution by at least one of the one or more processors capable of performing a method, the method comprising:
determining whether a participant UID corresponding to a participant matches a meeting UID;
based on determining that the participant UID does not match the meeting UID, collecting participant data corresponding to the participant;
extracting one or more features from the collected participant data; and
routing the participant to join one or more meetings based on applying one or more models to the extracted one or more features.

16. The computer system of claim 15, wherein the one or more models correlate the one or more features with the one or more meetings.

17. The computer system of claim 15, further comprising:
receiving feedback indicative of whether one or more participants were appropriately routed to one or more meetings; and
adjusting the model based on the received feedback.

18. The computer system of claim 15, further comprising:
prompting one or more participants to provide identification data;
and wherein the collected participant data includes the provided identification data.

19. The computer system of claim 15, wherein the participant data includes data selected from a group comprising calendars, profiles, schedules, business directories, employee listings, government listings, social networks, smart device contacts, email contacts, social media contacts, audio, video, and text.

20. The computer system of claim 15, wherein the one or more features include features selected from a group comprising a name, username, serial number, employer, job title, security clearance, responsibilities, extracurricular activities, plans, and hobbies.
